(19) United States
(12) Patent Application Publication
(10) Pub. No.: US 2005/0109762 A1
(43) Pub. Date: May 26, 2005

(54) Coffee saver

(76) Inventor: John M. Rice, Hopkins, MN (US)

Correspondence Address: ALBERT W. WATKINS, 30844 NE 1ST AVENUE, ST. JOSEPH, MN, 56374, US

(21) Appl. No.: 10/750,738

(22) Filed: Dec. 31, 2003

Related U.S. Application Data
(60) Provisional application No. 60/437,550, filed on Dec. 31, 2002.

(51) Int. Cl. H05B 3/68

(52) U.S. Cl. 219/443.1

(57) ABSTRACT

A wedge spaces and tilts a coffee pot relative to a warming surface. The wedge enables thermal convection currents in air to form a thermal blanket about the coffee pot. The slight tilt ensures that small amounts of coffee pool adjacent the point of contact with the warming surface. The wedge may carry indicia or logos for advertising or other purpose. Most preferably, the wedge is small relative to the warming surface and coffee pot base, and will not only therefore form a suitable spacer, but also be small enough to be incorporated into beverage packaging such as in a coffee can or the like beverage retail container.

### CROSS REFERENCE TO RELATED APPLICATIONS

This application claims priority to United States provisional patent application Ser. No. 60/437,550 filed Dec. 31, 2002, invented by the present inventor and entitled “Coffee Flavor Protector”, the contents which are incorporated herein by reference in entirety.

### BACKGROUND OF THE INVENTION

1. FIELD OF THE INVENTION

This invention pertains to the food service industry generally, and more particularly to methods and apparatus for preserving hot beverages in a warm state using a dispensing pot. In a most preferred manifestation, the invention pertains to an apparatus used in combination with beverage infusers to control the thermal conduction extent and distribution within the pot.

2. DESCRIPTION OF THE RELATED ART

In the present food industry, many beverages are most preferably served in a hot state, much warmer than ordinary room temperature. While there are too many beverages to specifically mention herein, such beverages include coffee, relatedlattes and the like, teas, cocoas and chocolate beverages, herbal infusions and decoctions, and even soups and other compositions that may be more or less liquid in nature. While coffee is perhaps the most prevalent beverage in the American food service industry generally, and the beverage for which the present invention was developed owing to the storage and serving practices commonplace both in commercial and home serving and for which special benefit may be obtained, the present invention pertains to any of the aforementioned or other contents, the specific contents not essential to the workings of the present invention.

In both commercial and household brewing of coffee, a coffee brewing appliance is utilized which comprises a pot for ultimately receiving brewed coffee therein, a reservoir for water, an infusion stage which typically comprises a filter basket into which ground coffee is placed, a water heater which elevates the liquid coming from the reservoir to approximately boiling temperatures, conduits to conduct the water from reservoir to infusion device and from infusion device to pot, and a pot heater to maintain the brewed coffee at suitable elevated temperature. The materials selected for the pot often vary, but may typically include stainless steel and temperature resistant glass such as Pyrex or the like. The specific construction and arrangement of the brewing machines are known to vary, and are generally of no consequence to the present invention, other than for the storage of the brewed beverage in a ready-to-serve container such as the typical pot on a warming surface or heater plate.

In an effort to ensure that the beverage is suitable for any consumer, these pot heaters have traditionally been designed to maintain the beverage at very elevated temperatures. This permits the consumer to allow the beverage to cool to their individual preferred temperature either by convection or conduction, or even through mixing with cold substances such as cream, milk, water, ice or the like. The serving of hot beverage permits this individual satisfaction, which is, of course, not possible when the temperature is too low for some patrons.

Unfortunately, as a result of the high temperature required to satisfy all or a vast majority of consumers, it is also known that beverages such as coffee will quickly degrade through a combination of oxidation, evaporation of volatile components, and even the occasional undesired scorching. This degradation is very severe, and will typically occur in an hour or less on many common coffee pot warmers. This degradation consequently affects the flavor of the coffee very adversely, reducing the quality of the flavor for a consumer, and eventually requiring that the coffee be disposed of completely. A bad cup of coffee will spoil an otherwise good dining experience, and may lead to undesirable adverse publicity about an establishment. Continual brewing of fresh coffee, which is necessary to avoid the lessening or ruining of patron dining experiences, is not only undesirable, but also difficult to time and ensure.

One of the primary limitations of the prior art has been the inherent temperature differential which is formed between the hot plate, the beverage pot, the surrounding air, and the beverage. To further elucidate, when a hot plate is in contact with the bottom of the beverage pot, the liquid therein will be heated primarily from the bottom. Since the stainless steel and glass beverage containers in common use are poor thermal conductors, the heat provided through conduction at the bottom of the container is primarily not conducted through walls which extend vertically, but is instead primarily conducted directly into the liquid adjacent the bottom of the pot. This leads to a heating at the bottom, and subsequent cooling at the surface and along the walls of the pot. In turn, this will lead to a temperature-induced circulation of beverage from the hot plate generally up the center of the pot into contact or near the surface, followed by subsequent cooling. This cooling continues as the beverage then travels along the outer walls of the beverage pot and back down to the area more nearly adjacent the beverage warming plate. This circulation is increased as the temperature differential between the warming plate and the surface increases. In the most prevalent prior art designs, the surface and outside walls of the pot are closer to ambient room temperature. Consequently, these prior art designs with hot base and cool surface and walls lead to optimum conditions for the spoiling of the beverage.

Recognizing a demand for more flexible temperature control, some have designed variable temperature control into a coffee pot warming device. Exemplary patents that illustrate this technique include U.S. Pat. No. 4,206,341 by Leuschner et al; and U.S. Pat. No. 4,772,777 by Weller et al; the contents of each which are incorporated herein by reference for their teachings. Unfortunately, and as aforementioned, this approach has not met with desired success, owing to the different tastes of individual consumers, each which may prefer different temperatures. Consequently, an individual consumer may opt for the temperature regulation illustrated in these aforementioned patents, and thereby extend beverage serving life, presuming they prefer lower temperature beverages. Nevertheless, the primary causes of beverage degradation are not reduced or eliminated by this simple temperature reduction, and more than one consumer may not be satisfied. Furthermore, the cost of these more complex temperature control schemes make these types of beverage appliances far more expensive than that which would be desired.

In order to reduce the costs associated with variable temperature control, and further permit the easy retrofitting of existing appliances, several artisans have proposed relatively more simple means to reduce the temperature or heat conduction which is achieved by the warming appliance. Examples of this include the fabric disk of Quinn et al in U.S. Pat. No. 6,246,032 and the insulating temperature attenuator ring of Roland et al in U.S. Pat. No. 4,994,649; the contents of each which are incorporated by reference herein for their teachings. Nevertheless, and as aforementioned, temperature control by itself does not provide the desired benefits of longer beverage serving times and satisfaction of all consumers.

Others have provided alternatives that go beyond temperature control alone. Many alternatives have been presented, including such devices as the floating cover of Wasserman et al in U.S. Pat. No. 4,764,391, which reduces the total exposure of the liquid to air; U.S. Pat. Nos. 4,825,046 and 5,073,699 by Box, which illustrate a spacer having bumps specifically for a coffee warming plate; the air gap apparatus of U.S. Pat. No. 4,715,269 by Stoner, U.S. Pat. No. 5,196,677 by Stasyshyn, and U.S. Pat. No. 6,286,415 by Leung; and the spring controlled air gap mechanisms illustrated in U.S. Pat. No. 4,158,125 by Jones and U.S. Pat. No. 5,183,995 by Addison et al; the contents of each which are incorporated herein by reference for their teachings. A great many additional patents been granted which illustrate various warming concepts, including U.S. Pat. No. 6,340,808 by Joergensen; U.S. Des. Pat. No. 388,659 by Doyle et al; U.S. Pat. No. 4,798,937 by Guerrero; U.S. Des. Pat. No. 306,118 by Guerrero; U.S. Des. Pat. No. 342,865 by Addison et al; U.S. Des. Pat. No. 340,383 by Addison et al; U.S. Des. Pat. No. 342,865 by Addison et al; U.S. Des. Pat. No. 357,385 by Addison et al; U.S. Des. Pat. No. 245,663 by Gordon; U.S. Des. Pat. No. 408,216 by Hellebjerg et al; U.S. Des. Pat. No. 254,141 by Kenfield; U.S. Des. Pat. No. 469,597 by Reid; U.S. Des. Pat. No. 881,199 by Palmer; U.S. Des. Pat. No. 928,634 by Cruickshank; U.S. Des. Pat. No. 966,579 by Myers; U.S. Pat. No. 1,109,323 by Cruickshank; U.S. Pat. No. 1,392,868 by Cruickshank; U.S. Des. Pat. No. 1,465,133 by Hubbard; U.S. Pat. No. 2,003,773 by Gross; U.S. Pat. No. 2,365,615 by Woodman; U.S. Pat. No. 2,872,560 by Bowles; U.S. Pat. No. 3,687,127 by Mossman, Sr.; U.S. Pat. No. 3,679,869 by Keeler et al; U.S. Pat. No. 5,539,856 by Andrew et al; U.S. Des. Pat. No. 68,722 by Longacre; U.S. Des. Pat. No.276,973 by Crossley; U.S. Des. Pat. No. 364,534 by Brown et al; and U.S. Des. Pat. No. 364,993 by Andrea; the contents of each which are also incorporated herein by reference for their teachings. Some of these patents illustrate techniques which will provide an air jacket around the beverage, which will thereby tend to reduce the natural convection currents within the beverage pot. However, these approaches as illustrated are again expensive, difficult to manufacture, and undesirably large. While there are certainly many varied approaches to the warming of coffee, the solutions presented in the herein above have not, either individually or in combination, provided the full combination of benefits desired herein.

### SUMMARY OF THE INVENTION

In a first manifestation, the present invention is a combination beverage pot and warming surface. The beverage pot is suitable for retaining a liquid beverage therein and has a base. The warming surface provides a source of heat which couples with the beverage pot base for maintaining liquid beverage at a temperature elevated with respect to a surrounding ambient temperature. A spacer is provided between one portion of the beverage pot base and warming surface, to elevate a majority of the beverage pot base above and separate from the warming base, while tilting the beverage pot base relative to the warming surface.

In a second manifestation, the invention is a coffee serving apparatus. A liquid retaining pot has a base and side walls, and retains a liquid therein. A heating base provides thermal energy adequate to elevate the liquid retaining pot and any liquid retained therein at a temperature elevated with respect to ambient. A means is provided to tilt the liquid retaining pot with respect to heating base, while maintaining the liquid retaining base in point contact with the heating base. Retained liquid is pooled to a maximum depth adjacent the point contact.

In a third manifestation, the invention is a method for extending the serving life of a warm beverage held within a pot, wherein the pot has a generally planar bottom parallel, adjacent with and warmed upon a generally surface. According to the method, a spacer is placed upon the warming surface in a location offset from center with respect thereto. The pot is placed upon spacer and surface so that a minority portion of the pot bottom is supported upon the spacer and a second minority portion of the pot bottom is supported upon the surface. A majority portion of the pot bottom is spaced from but maintained adjacent and elevated with respect to the warming surface. The warming surface is heated above ambient, and forms an air blanket about the pot through thermally induced air convection currents.

### OBJECTS OF THE INVENTION

Exemplary embodiments of the present invention solve inadequacies of the prior art by providing a small spacer which forms a distinct air gap between beverage pot and warmer, while not generally interfering with the use or operation of the beverage warmer.

A first object of the present invention is to provide a means for extending the serving life of sensitive beverages such as coffee and the like. A second object of the invention is to enable these sensitive beverages to be served at relatively higher temperatures for a given serving life than was heretofore possible. Another object of the present invention is to provide a readily selectable combination, whereby the apparatus in accord with the present invention may be selectively incorporated or removed without altering the remaining features of warmer and beverage pot. A further object of the invention is to provide a readily manufactured and low-cost apparatus, which will be readily understood and implemented by as many persons as possible without added instructions or unnecessary complexity. Yet another object of the present invention is to provide an apparatus of small size which may be easily included in a beverage container or the like, and which may further include advertising, logos or other commercial insignia.

### BRIEF DESCRIPTION OF THE DRAWINGS

The foregoing and other objects, advantages, and novel features of the present invention can be understood and appreciated by reference to the following detailed description of the invention, taken in conjunction with the accompanying drawings, in which:

FIG. 1 illustrates a preferred coffee saver designed in accord with the teachings of the present invention in combination with a coffee pot and coffee warming plate from an operative partial side cut-away view.

FIG. 2 illustrates the preferred coffee saver of FIG. 1 from a top plan view further illustrating an advertising logo imprinted thereon.

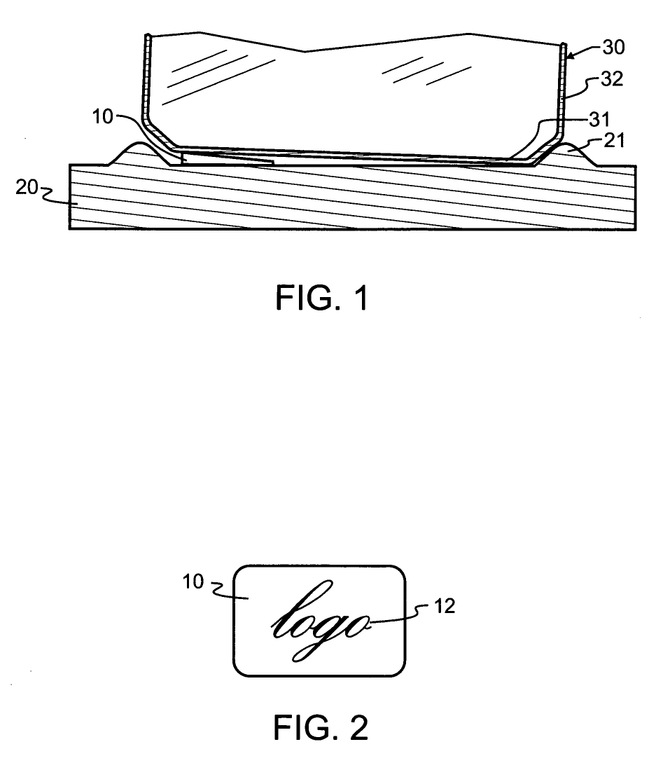

### DESCRIPTION OF THE PREFERRED EMBODIMENT

Manifested in the preferred embodiment, the present invention provides a small coffee saver apparatus 10 to limit direct contact between beverage pot 30 and warming surface 20. Preferably, coffee saver 10 will maintain a relatively small gap between beverage pot bottom 31 and warming surface 20, sufficient to provide air flow adjacent to beverage pot 30. Warm air convection from warming surface 20 will tend to envelope pot 30 in a warm air jacket, thereby raising the temperature of the side walls 32 of beverage pot 30. This warm air convection, which tends to jacket beverage pot 30, in turn reduces the temperature differential between beverage pot side walls 32 and the beverage therein, and further tends to reduce the temperature differential between the liquid and air at the top of the beverage. This in turn reduces the natural convection within the beverage pot, while tending to better equilibrate the temperature therein, thereby reducing convection, undesired oxidation, and evaporation of volatile constituents, while providing slightly more consistent temperature throughout the liquid.

In the most preferred embodiment illustrated by the figures herein, coffee saver will take the form of a generally rectangular wedge which will slightly tilt beverage pot 30 with respect to warming surface 20, reducing physical contact between beverage pot 30 and warming surface 20 to a small region opposite wedge 10. This in turn ensures that the last liquid within pot 30 will additionally be pooled towards one surface, inherently providing the benefit of reduced thermal overshoot and thermal shock outlined in the Joergensen referenced herein above. Most preferably, coffee saver 10 will be of relatively small size with respect to beverage pot bottom 31, extending less than the radius thereof and similarly extending across half or less of the arc formed by coffee pot bottom 31, which typically circumscribes a full circle or 360 degrees, to ensure suitable tilt of beverage pot 30. Most preferably, coffee saver 10 will extend but a minor portion of the radius and circumference, extending less than one-quarter of the diameter and less than one-eighth of the circumference. Most preferably, contact between beverage pot bottom 31 and coffee saver 10 will be only a minority of the area of beverage pot bottom 31. Likewise, most preferably the contact between beverage pot bottom 31 and warming surface 20 will be only a minority of the area of beverage pot bottom 31. Most preferably, a majority of beverage pot bottom 31 will be spaced from and adjacent to warming surface 20.

Additionally, coffee saver 10 will most preferably have a thickness or height less than retaining ridge 21, so as to not disrupt or interfere consequentially with the stability of beverage pot 30 within retaining ridge 21.

While in the preferred embodiment, coffee saver 10 has a generally rectangular outline as shown in FIG. 2, the actual outline may take on any geometry and may further encompass artistic designs. These designs may have some functional benefit or may not, and may optionally be simulative of plants, animals, or other. Likewise, coffee saver 10 is preferred to have a wedge or tapered thickness for reasons outlined herein below, but may alternatively have any other thickness profile suitable for a given design, including but not limited to enhancing an artistic appearance.

The material for coffee saver 10 is not critical to the proper operation as described herein, and may comprise any material which would be suitable for the temperatures likely to be encountered. Preferably, the material will also be one which may be cleaned when required, and which will not readily absorb liquids. In a most preferred manifestation, coffee saver 10 may be formed in much the way of a small coin, through appropriate stamping technique. Logo 12 may then be formed simultaneously, if so desired. Similarly, the materials for beverage pot 30 and warming surface 20 are not critical, and will be designed in accord with the teachings of the prior art and the documents incorporated herein by reference. Most typically, beverage pots such as pot 30 are manufactured from thermally and chemically resistant glass such as that sold under the Pyrex trademark or from food grade stainless steel, while warming surface 20 will be manufactured from aluminum or ferrous metals, and will typically be heated electrically. In operation, a person warming a beverage pot will selectively place coffee saver adjacent retaining ridge 21 of warming surface 20, typically adjacent the back of warming surface 20 farthest from the person, though not limited thereto. The benefit of placement away from the person is the natural ability of coffee pot bottom 31 to rise up and over coffee saver 10 when in sliding contact therewith and moved with respect thereto. The general wedge shape, which in the preferred embodiment decreases in thickness with decreasing distance from the center of coffee pot bottom 31, enables this relative sliding motion. Next, beverage pot 30 will then be placed onto warming surface 20 and nestled between retaining ridge 21 and wedge 10.

Most preferably, advertising, logos, designs, or other insignia 12 will be provided on coffee saver 10. This permits coffee saver 10 to be distributed as a premium or advertising promotional product, thereby gaining significant benefit to a commercial manufacturer, food distributor, producer or the like. Furthermore, owing to small size, coffee saver 10 may be incorporated directly into the packaging of another product, such as ground coffee or the like.

Several alternative embodiments are contemplated herein, but are by no means intended to be limiting thereto. Instead, these alternatives are exemplary of alternatives that are recognized herein which are presented to further enable those skilled in the art after a thorough review of the foregoing preferred embodiment. A first alternative embodiment to coffee saver 10 is a mechanical lifting device incorporated directly into warming surface 20. A pin or the like would, in this embodiment, be activated by pushing in or out a button or by the activation of a cam or other similar mechanical coupling. While such a lifting mechanism would help to preserve a beverage, this construction certainly requires more complexity, cost, and does not provide the ability to retrofit.

A second contemplated alternative embodiment is a suspension system attached directly to pot 30, such as suspending pot 30 from its spout, handle or other suitable feature. Most preferably, such suspension will allow a small part of coffee pot bottom 31 to contact warming surface 20, similar to preferred embodiment coffee saver 10.

While the foregoing details what are felt to be the preferred and alternative embodiments of the invention, no material limitations to the scope of the claimed invention are intended. Further, features and design alternatives that would be obvious to one of ordinary skill in the art are considered to be incorporated herein. The scope of the invention is set forth and particularly described in the claims herein below.

1. A combination beverage pot and warming surface having a beverage pot suitable for retaining a liquid beverage therein and a base, and a warming surface providing a source of heat which couples with said beverage pot base for maintaining said liquid beverage at a temperature elevated with respect to a surrounding ambient temperature, wherein the improvement comprises a spacer between one portion of said beverage pot base and said warming surface to elevate a majority of said beverage pot base above and separate from said warming base while tilting said beverage pot base relative to said warming surface.

2. The combination beverage pot and warming surface of claim 1 wherein said spacer further comprises a wedge defined by a thickness generally decreasing with decreasing distance from a center of said beverage pot base.

3. The combination beverage pot and warming surface of claim 2 wherein said wedge further comprises a rectangular outline from top plan view.

4. The combination beverage pot and warming surface of claim 2 wherein said wedge further comprises insignia upon a surface.

5. The combination beverage pot and warming surface of claim 2 wherein said wedge thickness is less than an elevation of a pot retaining feature in said warming surface.

6. The combination beverage pot and warming surface of claim 1 wherein said spacer further comprises stamped metal.

7. A coffee serving apparatus comprising:
a liquid retaining pot having a base and side walls and retaining a liquid therein;
a heating base providing thermal energy adequate to elevate said liquid retaining pot and any liquid retained therein at a temperature elevated with respect to ambient; and
a means to tilt said liquid retaining pot with respect to said heating base while maintaining said liquid retaining pot base in point contact with said heating base, said retained liquid pooled to a maximum depth adjacent said point contact.

8. The coffee serving apparatus of claim 7 wherein said tilting means further comprises a wedge defined by a thickness generally decreasing with decreasing distance from a center of said liquid retaining pot base.

9. The coffee serving apparatus of claim 7 wherein said tilting means further comprises visible insignia.

10. The coffee serving apparatus of claim 8 wherein said heating base further comprises a means for retaining a pot therein, said wedge thickness less than an elevation of said pot retaining feature.

11. The coffee serving apparatus of claim 7 wherein tilting means supports a minority portion of said liquid retaining pot.

12. A method for extending the serving life of a warm beverage held within a pot having a generally planar bottom parallel, adjacent with and warmed upon a generally planar surface, comprising the steps of:
placing a spacer upon said warming surface in a location offset from center with respect thereto;
supporting a minority portion of said pot bottom upon said spacer and a second minority portion of said pot bottom upon said surface, a majority portion of said pot bottom spaced from but adjacent and elevated with respect to said warming surface; and
heating said warming surface above ambient to form an air blanket about said pot through thermally induced air convection currents.

13. The method for extending the serving life of a warm beverage of claim 12, further comprising the step of selectively removing and cleaning said spacer.

14. The method for extending the serving life of a warm beverage of claim 12, further comprising the steps of:
selectively removing said pot from said warming surface and said spacer; and
dispensing said warm beverage.
